(19) United States
(12) Patent Application Publication
(10) Pub. No.: US 2026/0004762 A1
(43) Pub. Date: Jan. 1, 2026

(54) SOUND INSULATION DEVICE FOR AN AIRCRAFT

(71) Applicant: Airbus Operations SAS, TOULOUSE (FR)

(72) Inventors: Laurent CAZEAUX, TOULOUSE (FR); Arnulfo CARAZO MENDEZ, TOULOUSE (FR); Leana ROSSI, TOULOUSE (FR); Suresh PALANI, TOULOUSE (FR); Kevin BOUKHORS, TOULOUSE (FR)

(21) Appl. No.: 19/240,815

(22) Filed: Jun. 17, 2025

(30) Foreign Application Priority Data
Jun. 28, 2024 (FR) FR2407085

(51) Int. Cl. G10K 11/172; B64D 33/02

(52) U.S. Cl. CPC G10K 11/172; B64D 33/02; B64D 2033/0206

(57) ABSTRACT

A sound insulation device comprising at least one cavity, called a quarter-wave cavity, a first abutment of two walls, respectively of a first strip and a second strip, in contact with each other, so that a passage is provided between the cavity and another cavity. The other cavity, called a Helmholtz cavity, is closed by an edge closure, a second joining of two walls, respectively of the first strip and the second strip, in contact with one another. Each of the walls of the first and second abutments include a portion arranged along the closing edge of the Helmholtz cavity, called the sacrificial portion and form the end of the covering.

### CROSS-REFERENCES TO RELATED APPLICATIONS

This application claims the benefit of the French Patent Application No. FR2407085 filed on Jun. 28, 2024, the entire disclosures of which are incorporated herein by way of reference.

### BACKGROUND OF THE INVENTION

The present invention relates to the field of sound insulation structures. The invention relates, in particular, to a sound insulation covering having an alveolar structure. The covering which is the subject of the invention can have applications, in particular, in the aeronautical field, for example in nacelles of aircraft power plants.

### SUMMARY OF THE INVENTION

Coverings or panels comprising an alveolar structure consisting of cells or alveoli, i.e., juxtaposed hollow unit volumes, are used in many technical fields, in particular, in the aeronautical field. They can have a high degree of rigidity with a low mass. The coverings comprise an alveolar structure having cells which are open on one face, or at least cells communicating with the outside of the panel, which are used for their sound insulation properties. Such panels are sometimes called acoustic panels.

The panels or coverings having an alveolar structure can be formed from various materials, for example, plastic, composite or metallic. The cells can have different geometries. A well-known shape of an alveolar structure has cells having a straight prism shape with a hexagonal base. This is often called a “honeycomb” structure to denote this type of hexagonal cell structure, but this expression is also used inaccurately to denote alveolar panels having other shapes of cells.

Thus a conventional acoustic panel or covering generally comprises a honeycomb core interposed between a sheet which is perforated or comprises a metallic fabric which is permeable to acoustic waves forming a first face and a closing sheet, which is generally solid, sealing the cells and forming a second face of the covering.

The cells of the acoustic panels act as small resonators permitting the absorption of acoustic waves over a given frequency range. So that a resonator is efficient, its range of absorption frequencies has to comprise the frequency to which the panel is subjected. However, the relatively small-sized cavities of the acoustic panels correspond to high frequencies. Thus, it is difficult to obtain an efficient alveolar panel for some applications which are subjected to low frequencies.

For example, the power plants of commercial aircraft comprise a turbomachine engine and a nacelle which can comprise an acoustic covering to attenuate the noise generated during the operation of the engine. Nevertheless, the sound frequencies generated by the engine of an aircraft are relatively low and extend over a fairly broad range. The low frequencies having to be attenuated are, for example, frequencies below 2000 Hz depending on the engine under consideration. The uptake of power plants of large diameter tends to lower even further the frequencies of the acoustic waves which they generate, in particular, below 1000 Hz. However, the need to have cells of large volume to absorb low frequencies results in panels of large thickness, which are not very compatible with an aeronautical application.

An object of the invention is to remedy at least partially these drawbacks.

### SUMMARY OF THE INVENTION

To this end, a sound insulation device is proposed, in particular for an aircraft, comprising a first sheet which is perforated with orifices, called an open sheet, which is permeable to acoustic waves, a second sheet, called a closing sheet, and a sound insulation covering arranged between the first sheet and second sheet, the covering being formed by the abutment in one direction, called the transverse direction, of a plurality of alveolar structures, each of the alveolar structures being formed by the abutment in the transverse direction of a first longitudinal strip and a second longitudinal strip, the first strip and the second strip which form an alveolar structure being configured such that the alveolar structure has in a longitudinal direction, at right-angles to the transverse direction: at least one cavity which is open in the region of the first sheet and of which a cross section gradually reduces between the first sheet and the second sheet until the cavity is closed, called the quarter-wave cavity, a first abutment of two walls, respectively of the first strip and of the second strip, in contact with each other, such that a passage is formed between the cavity and another cavity, the other cavity, called the Helmholtz cavity, which has a cross section gradually increasing between the first sheet and the second sheet and which is closed in the region of the first sheet and in the region of the second sheet by a closing edge, and a second abutment of two walls, respectively of the first strip and of the second strip, in contact with each other, each of the walls of the first and second abutments comprising a portion arranged along the closing edge of the Helmholtz cavity, called the sacrificial portion.

Thus the device according to the present invention enables an effective acoustic treatment of low frequencies, while having good structural qualities and being able to be manufactured, the sacrificial portion avoiding, in particular, the perforation of the Helmholtz cavity when the first sheet is perforated in order to make it permeable to the acoustic waves.

According to a further aspect, the sacrificial portion has a height in one direction, called the vertical direction, at right-angles to the longitudinal direction and the transverse direction, of between 1% and 30% of the height in the vertical direction of the covering, preferably between 5% and 25%. According to a further aspect, each sacrificial portion extends in the longitudinal direction and the vertical direction.

According to a further aspect, at least one alveolar structure has a pattern which is repeated along at least one of the longitudinal or transverse directions.

According to a further aspect, the pattern comprises an assembly of one quarter-wave cavity and one Helmholtz cavity in succession.

According to a further aspect, the pattern comprises an assembly of two quarter-wave cavities and one Helmholtz cavity in succession.

According to a further aspect, the pattern comprises an assembly of two Helmholtz cavities and one quarter-wave cavity in succession.

According to a further aspect, at least one of the alveolar structures comprises at least one conduit for discharging water from the covering.

According to a further aspect, at least one of the alveolar structures comprises at least two conduits for discharging water from the covering, each of the conduits being at a separate given height in the vertical direction.

According to a further aspect, the device comprises at least one cavity, called the intermediate cavity, which is closed between a Helmholtz cavity and a quarter-wave cavity.

A further subject of the invention is a nacelle for an aircraft engine, comprising a sound insulation device as described above.

A further subject of the invention is also an aircraft comprising a sound insulation device as described above.

### BRIEF DESCRIPTION OF THE DRAWINGS

Further features, details and advantages will become apparent from reading the following detailed description and analyzing the accompanying drawings, in which:

FIG. 1 shows according to a schematic three-dimensional view an acoustic covering according to the prior art.

FIG. 2 shows according to a schematic three-dimensional view the constituent elements of the covering of FIG. 1.

FIG. 3 shows according to a schematic three-dimensional view the elements of FIG. 2 after assembly.

FIG. 4 is a schematic perspective view of a detail of a sound insulation covering of a sound-proofing device according to a first embodiment of the invention.

FIG. 5 is a schematic front view of the detail of FIG. 4.

FIG. 6 is a schematic side view of the detail of FIG. 4.

FIG. 7 is a schematic perspective view of a detail of a sound insulation covering of a sound-proofing device according to a second embodiment of the invention.

FIG. 8 is a schematic front view of the detail of FIG. 7.

FIG. 9 is a schematic side view of the detail of FIG. 7.

FIG. 10 is a schematic perspective view of a detail of the sound insulation covering of a sound-proofing device according to a third embodiment of the invention.

FIG. 11 is a further schematic perspective view of the detail of FIG. 10.

FIG. 12 is a schematic front view of the detail of FIG. 10.

FIG. 13 is a perspective view of the detail of FIG. 10 according to a variant.

FIG. 14 shows schematically in a sectional view an aircraft power plant, the nacelle thereof being provided with a sound-proofing device according to the present invention.

### DETAILED DESCRIPTION OF THE PREFERRED EMBODIMENTS

The examples and associated stipulations detailed here are primarily designed to assist the reader to understand the principles of the present invention and not to limit its scope to these specific examples and stipulations. It will be understood that a person skilled in the art can conceive of various arrangements which, although not explicitly described or shown here, nevertheless incorporate the principles of the present invention and are included in the spirit and the scope thereof.

Moreover, in order to facilitate comprehension, the following description can describe relatively simplified embodiments of the present invention. As understood by a person skilled in the art, further embodiments of the present invention can be of a greater complexity.

In certain cases, modifications of the present invention can also be presented. This is done simply as an aid to comprehension, and once again not to define the scope or establish limits of the present invention. These modifications are not an exhaustive list and a person skilled in the art could provide further modifications while remaining within the scope of the present invention.

Moreover, all of the statements made hereinafter relative to the principles, aspects and embodiments of the present invention, in addition to the specific examples thereof, aim to encompass both structural and functional equivalents thereof, whether they are currently known or developed in the future.

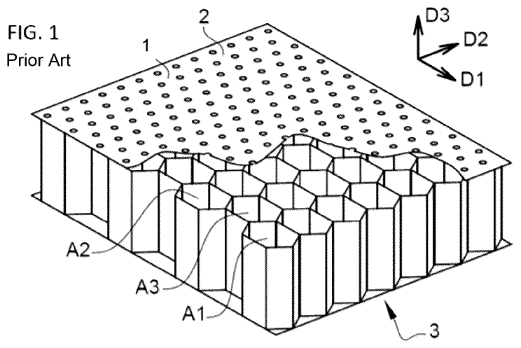

FIG. 1 shows schematically a sound insulation device comprising a sound-proofing covering, known in the prior art. It comprises cells (or cavities) A1, A2, A3, etc., juxtaposed with one another in two directions at right-angles to one another so as to form an alveolar structure. A first juxtaposition direction D1 of the cells is called the longitudinal direction and a second juxtaposition direction D2 of the cells, at a right-angle to the first direction D1, is called the transverse direction. A third direction D3, in which the thickness of the panel extends, is defined at a right-angle to the first direction D1 and to the second direction D2. The third direction D3 can be conventionally called the vertical direction D3 (without being influenced by the orientation of the sound-proofing covering).

As can be seen in FIG. 1, the cells A1 . . . . A3 are open on a first face of the covering. A perforated sheet 2 covers the cells, forming a resistive surface enabling the communication of the cells A1 . . . . A3 with the external environment, so that the first face is called the open face. The sheet 2 is called the open sheet.

On a second face the cells, A1 . . . . A4 are closed by a closing sheet 3, for example a solid sheet, sealing the bottom of the cells.

In the prior art, as in the invention, the closing sheet is generally a solid sheet. It can nevertheless be a sheet having perforations. More specifically, a solid sheet is used for simple acoustic treatments, called SDOF according to the English expression “Single Degree of Freedom” and forms a rear skin which is reflective relative to acoustic waves. A closing sheet having perforations is used for acoustic treatments called DDOF according to the English expression “Double Degree of Freedom” for which a stack of two honeycomb stages is produced, the stages being separated by an intermediate porous skin formed by the closing sheet.

Although not excluded, the stacking of two alveolar structures, as formed in the invention and of which the examples are described hereinafter with reference to the following figures, has a generally limited interest since such a stacking of structures generally leads to a thick acoustic covering, while the structure developed in the invention enables the thickness of the structure to be limited compared to the known structures enabling the treatment of similar sound frequencies.

In FIG. 1, the cells of the alveolar structure shown here are called hexagonal, in that their volume is that of a straight prism having a hexagonal base extending between the first face and the second face of the sound-proof covering.

The hexagonal cells are arranged so as to be staggered with a longitudinal offset, enabling them to be interlocked without a dead volume.

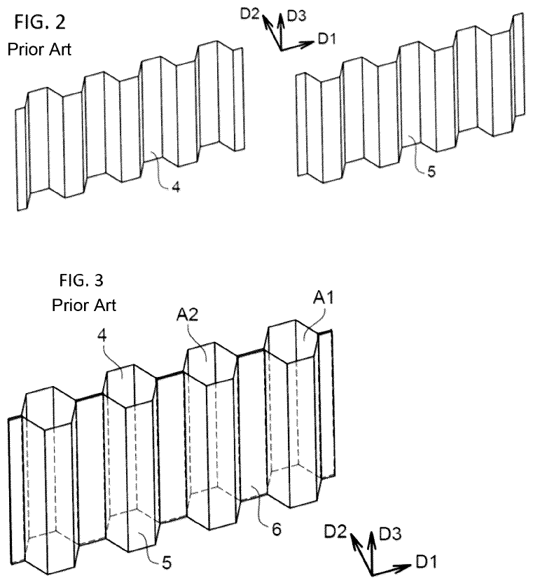

FIG. 2 shows two strips enabling the formation of the cellular structure of the covering of FIG. 1, according to a technique known in the prior art on which the present invention is based.

In particular, a first strip 4 has an undulation formed by successive regular folds. Each undulation forms half of a hexagonal cell. A second strip 5 is identical to the first strip 4.

The first strip 4 and the second strip 5 are abutted against one another so as to form a structure having a longitudinal succession of hexagonal cells A1, A2; the walls 6 being in contact and connected to one another therebetween, for example by adhesive bonding or welding. By abutting and fixing a further identical structure transversely (in the second direction D2) to the structure of FIG. 3, and so forth, the cellular structure of the covering of FIG. 1 is obtained.

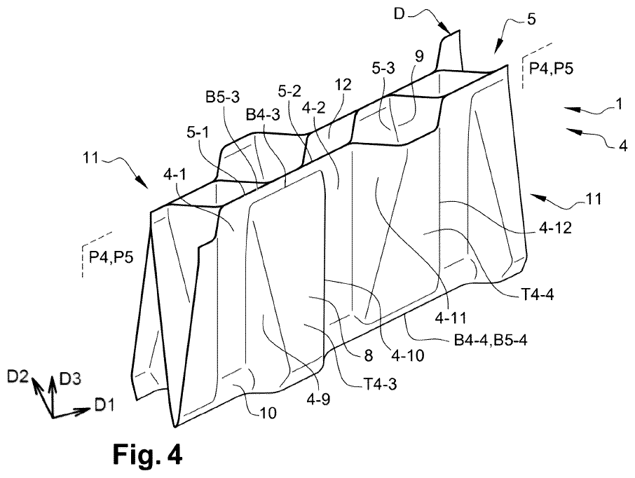

A sound insulation device D (also called a sound-proofing device D) is now described according to the present invention, in particular for an engine nacelle of an aircraft, with reference to FIG. 4 and thereafter.

As can be seen in FIG. 1, the device D comprises a sound insulation covering, referenced 1 in the figures. The device D also comprises a first sheet 2, called the open sheet, and a second sheet 3, called the closing sheet, which is preferably solid, the covering 1 extending between the first and second sheets 2, 3 as already described in relation to FIGS. 1 to 3. The ends of the covering 1 in the plane (D1, D2) are called the first face and second face. The first face leads into the first sheet 2 and the second face leads into the second sheet 3.

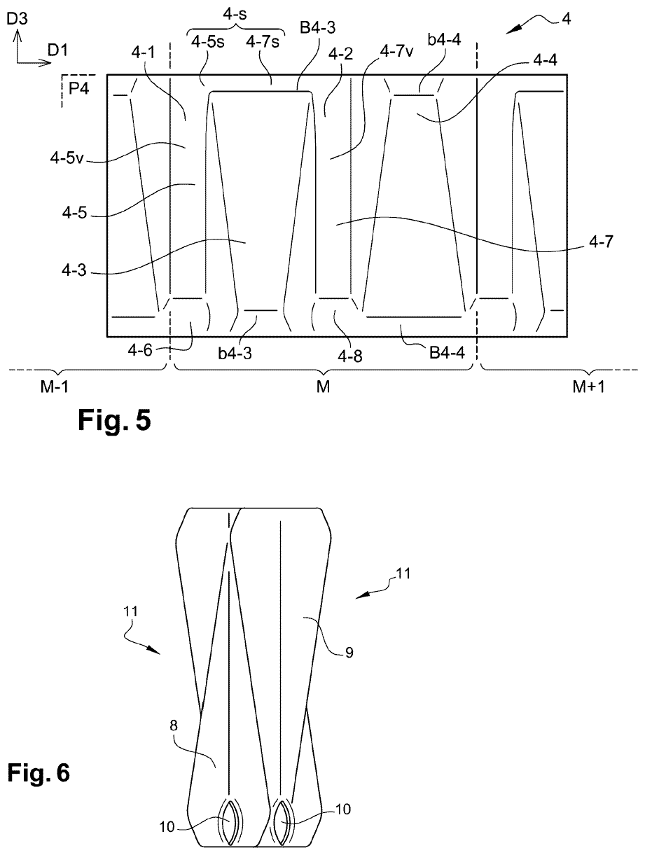

The invention is now described relative to FIGS. 4, 5 and 6.

FIG. 4 shows elements, namely pairs of strips 4 and 5, constituting the sound insulation covering 1. More specifically, FIG. 4 shows a small longitudinal portion (in the longitudinal direction) of the strips which are abutted and fixed to one another transversely (in the transverse direction D2).

Each of the strips 4, 5 extends substantially along a plane P4, P5 which itself extends in the longitudinal direction D1 and the vertical direction D3.

Each pair of strips 4 and 5 forms a first alveolar structure 11.

Each of the strips has deformations respectively in a single transverse direction. The deformations thus form hollows, respectively relative to their respective planes.

According to their simplest design, each strip is metallic and shaped by a forming technique. The conceivable forming techniques comprise, for example, stamping and hydroforming.

The strip 4 is described in detail.

As is visible in FIGS. 4 to 6, the first strip 4 comprises, in succession, an assembly of patterns M which is repeated in the longitudinal direction D1. Each pattern M comprises a first portion 4-1 and a second portion 4-2 arranged on either side of a first half-cavity 4-3. Each pattern M also comprises a second half-cavity 4-4.

Half-cavities 4-3, 4-4 are referred to, since the assembly of the strip 4 to the strip 5 forms “complete” cavities by opposing the half-cavities 4-3, 4-4 with the half-cavities of the strip 5, as will be detailed hereinafter.

The first portion 4-1 comprises a wall 4-5 extending substantially in the plane P4 and extended by a half-passage 4-6 formed between the first half-cavity 4-3 and the second half-cavity 4-4 of the preceding pattern M−1. The half-passage 4-6 comprises a hemisphere which is integral with the rectangular wall 4-5.

The wall 4-5 has an overall L-shape, substantially comprising two rectangular parts about the first half-cavity 4-3. A first wall, called the sacrificial half-wall 4-5s, extends above a closing edge of the first half-cavity 4-3, forming the end (in the direction D3) of the covering 1, while a second wall 4-5v, extends principally in the direction D3.

The second portion 4-2 comprises a wall 4-7 extending substantially in the plane P4 and extended by a half-passage 4-8 formed between the first half-cavity 4-3 and the second half-cavity 4-4 of the pattern M. The half-passage 4-8 comprises a hemisphere which is integral with the rectangular wall 4-5.

The wall 4-7 comprises two rectangular parts forming an L-shape about the first half-cavity 4-3. A first wall, called the sacrificial half-wall 4-7s, extends above a closing edge of the first half-cavity 4-3, forming the end (in the direction D3) of the covering 1, while a second wall 4-7v extends principally in the direction D3.

The sacrificial half-wall 4-7s extends in the extension of the sacrificial half-wall 4-5s. The assembly of the sacrificial half-walls 4-5s, 4-7s constitutes a sacrificial wall 4-s of the pattern M of the strip 4. The dimension in the direction D3 of the sacrificial portion 4-s is advantageously between 0.1 mm and 1 cm, preferably between 0.5 mm and 3 mm. In other words, the sacrificial portion has a height (along D3) of between 1% and 30% of the height (along D3) of the covering 1, preferably a height of between 5% and 25% of the height (along D3) of the covering 1.

In FIGS. 4 to 6, the first half-cavity 4-3 is delimited by a trapezium T4-3 of which a small base b4-3 and a large base B4-3 extend in the direction D1. In FIGS. 4 to 6, the large base B4-3 of the pattern M is arranged above the small base b4-3. Two walls 4-9, 4-10, which are substantially triangular, in a plane (D2, D3) connect one end of the large base B4-3 to one end of the small base b4-3 and respectively to the first portion 4-1 and to the second portion 4-2.

In FIGS. 4 to 6, the second half-cavity 4-4 is delimited by a trapezium T4-4 of which a small base b4-4 and a large base B4-4 extend in the direction D1. In FIGS. 4 to 6, the small base b4-4 of the pattern M is arranged above the large base B4-3. Two walls 4-11, 4-12, which are substantially triangular, in a plane (D2, D3) connect one end of the large base B4-4 to one end of the small base b4-4 and respectively to the second portion 4-2 and to the first portion 4-1 of the following pattern M+1.

In the example shown here, the first strip 4 and the second strip 5 are of similar shapes, as a mirror image of one another, such that they are symmetrical to one another when they are abutted, relative to their abutment plane.

The first strip 4 and the second strip 5 are abutted and assembled, namely the plane P4 is placed in contact with the plane P5. The strips are fixed to one another, for example, by adhesive bonding or welding of their contact zones, in particular, between their respective first portions 4-1, 5-1 and between their respective second portions 4-2, 5-2. The first half-cavity 4-3, of the first strip 4 is placed opposite the first half-cavity 5-3 of the second strip 5, thus forming a first cavity 8. The large bases B4-3 and B5-3 are placed in contact with each other and form the closing edge of the cavity 8. The second half-cavity 4-4 of the first strip 4 is placed opposite the second half-cavity 5-4 of the second strip 5, thus forming a second cavity 9. The small bases b4-4. b5-4 are placed in contact with each other and form the bottom of the covering 1 (in the horizontal position of the aircraft). The half-passages of the first strip 4 are placed opposite the second half-passages of the second strip 5, thus forming a passage 10 between the first cavity 8 and the second cavity 9.

The sacrificial walls 4-s, 5-s are also placed in contact when the strips 4 and 5 are abutted together.

In other words, when the strips 4 and 5 are abutted against one another, the wall 4-1 is in contact with the wall 5-1 (forming a first abutment), on the one hand, and the wall 4-2 is in contact with the wall 5-2 (forming a second abutment), on the other hand, each of the first and second abutments comprising a sacrificial portion, respectively 4-5s, 5-5s; 4-7s, 5-7s.

The assembly of the first strip 4 with the second strip 5 thus forms a three-dimensional structure extending substantially in the longitudinal direction D1 and shown in FIGS. 4 to 6.

As can be seen in the figures, the second cavity 9 is open on one face in a plane (D1, D2), this face corresponding to the first face 2 of the covering 1. The opening of the second cavity 9 is of hexagonal cross section. The cross section of the first cavity 8 is gradually reduced in the direction of the bottom F of the second cavity 9. In the example shown here, the cross section reduces to nothing and takes the form of a straight line at the junction of the first strip 4 with the second strip 5 forming the bottom of the second cavity 9, perpendicular to a median line of the hexagon formed by the opening of the second cavity 9. The bottom can be located in the region of the second sheet 3, as in the example shown here, or between the first face 2 and the second face 3. Thus, in the example shown here, in the region of the bottom, i.e., in the region of the second face 3 of the sound-proof covering, once this is formed (excepting the closing sheet, of small thickness, namely here a solid sheet, closing the second face 3) the first strip 4 is in contact with the second strip 5.

As can also be seen in the figures, the first cavity 8, which advantageously extends over the entire height (dimensions in the third direction D3) of the structure 11, will be closed once the covering is formed both in the region of the first face 2 and in the region of the second face 3. More specifically, the first cavity 8 has an identical shape to that of the second cavity 9, but with an opposing orientation in the third direction D3. Thus, in the region of the first face or in the vicinity thereof, the first strip 4 is in contact with the second strip 5, which closes the first cavity 8 in the region of the first face 2 of the covering 1. In particular, the contact between the first strip 4 and the second strip 5 can take the form of a straight line perpendicular to a median line of the hexagon formed by the cross section of the first cavity 8 in the region of the second face 3. Thus, in the region of the second face 3 where the first cavity 8 of the structure 11 is open in a hexagonal cross section, the first cavity 8 is closed once the covering formed by the closing sheet forms the second face 3.

The configuration shown here makes it possible to maximize the height of the second cavities 9 while maximizing the volume of the first cavities 8 (which makes it possible to treat lower frequencies than by using cavities of smaller volume) without losing any acoustic surface. There is no slope discontinuity in the height of the walls, which might lead to a solution which would be difficult to manufacture.

It is noteworthy that each second cavity 9 forms a quarter-wave resonator. The assembly comprising the passage 10 and the cavity 8 forms a Helmholtz resonator of which the neck is formed by the passage 10. The quarter-wave resonator and the Helmholtz resonator are thus coupled in series at the entry of the passage 10. Hereinafter, the cavities 8 are called “Helmholtz cavities” and the cavities 9 are called “quarter-wave cavities”.

As can be seen in the figures, the covering 1 comprises two adjacent structures 11 transversely mounted so as to be staggered, i.e., each first cavity 8 of a structure 11 is adjacent in the transverse direction D2 to two second cavities 9 of neighboring structures, and each second cavity 9 of a structure 11 is adjacent in the transverse direction D2 to two first cavities 8 of neighboring structures. In other words, staggered does not mean alternating or in succession but offset over two rows.

Such a staggered configuration can be obtained by the alternate mounting of structures 11 rotated by 180° relative to their neighbors, or by mounting with a longitudinal offset of one structure 11 out of two. The solution implementing a longitudinal offset nevertheless has the technical difficulty that, after assembly, the structures have offset longitudinal ends, which requires a particular treatment of the longitudinal edges of the covering (cutting off or filling this offset, etc.).

Due to the respective cross-sectional restrictions of the first cavities 8 and the second cavities 9, the first cavities 8 and second cavities 9 interlock with one another transversely, such that the walls defining the first and second cavities in the transverse direction D2 come into contact with each other.

It is noteworthy that the abutment of two structures 11 also forms intermediate cavities 12. The intermediate cavities 12 are located at longitudinal intervals between the first cavities and the second cavities of two transversely adjacent structures 11. The intermediate cavities 12 have a cross section of substantially parallelogram shape in the region of the first face 1. The intermediate cavities 12 extend transversely between the walls 4-2, 4-11, 5-2, 5-11 of the first strips and second strips in abutment with one another to form the structures 11. The intermediate cavities 12 are closed in the region of the second face 3 by the closing sheet installed in the region of the second face 3 of the sound-proofing covering. The cross section of the intermediate cavities 12 changes within the thickness of the sound-proofing covering (in the third direction D3) since this cross section depends on the cross sections of the Helmholtz cavity 8 and quarter-wave cavity 9 delimited around the intermediate cavity 12.

The formation of an alveolar structure for a sound-proofing covering by the abutment of complementary geometric structures, enabling them to be interlocked so as to form the desired cavities between one another, also makes it possible to avoid the abutment of multiple walls in the alveolar structure, which optimizes the mass of the covering.

It is noteworthy that the second cavities 9 and the intermediate cavities 12 lead into the first face 1 in a regular and perfectly interlocked manner. It is also noteworthy that the first cavities 8, having a hexagonal opening, and the intermediate cavities 12, having an opening of parallelogram cross section, lead into the region of the second face 3.

The intermediate cavities 12 form resonators capable of treating the different sound frequency ranges (a priori higher) than those treated by the first cavities and second cavities forming the coupling of the Helmholtz and quarter-wave resonators.

Thus, the acoustic covering has an alveolar structure having three types and dimensions of cavities, which makes it possible to treat a very broad frequency range, compared with a covering having a single geometry of cells.

The alveolar structure obtained by the transverse abutment of the structures 11, which are in turn obtained by the transverse abutment of shaped strips 4, 5, is thus relatively simple to implement and to use. It is also possible to provide a curvature, in particular a transverse curvature, to this alveolar structure.

As already indicated, the sound-proofing device D is obtained by adding a closing sheet, typically a solid sheet, on one of the surfaces of the alveolar structure, thus forming a closed face, and a resistive sheet (for example a metal or carbon sheet provided with multiple perforations or a sheet comprising a metallic fabric which is permeable to acoustic waves) on the other face, which thus remains open.

It is noteworthy that the sacrificial walls 4-s, 5-s ensure that during the perforation of the opening sheet 2, no Helmholtz cavity is perforated, which would make it inefficient for the absorption of acoustic waves. Thus, it is possible that the walls 4-s, 5-s are contacted during the course of the perforation but their height (in the direction D3) ensures that the Helmholtz cavities in turn remain intact.

As is visible in particular in FIG. 6, the device D also comprises drainage conduits. These drainage conduits are passages 10 (formed by two half-passages in each of the strips 4, 5) which extend over the entire length of the alveolar structure 11.

The drainage conduits 10 thus enable the discharge of water which could penetrate or form due to condensation in the alveolar structure of the covering.

In other words, the drainage comprises placing the cavities in relation to one another via passages of small cross section, permitting the circulation by gravity of water present in the structure as far as one or more discharge points. In the illustrated embodiments, the passages 10 (formed by two half-passages in each of the strips 4, 5) extend over the entire length of the alveolar structure 11, i.e., not only between the cavities 8, 9 but also in the intermediate cavities 12.

As regards the first and second cavities 8, 9, it is possible to permit the drainage in the region of the second face 3 which is closed. To achieve this, apart from the passage 10 formed between a first cavity 8 and a second neighboring cavity 9, a passage 10 which is similar or of smaller cross section is formed (by a half-passage formed in the second strip 5 and a half-passage correspondingly formed in the first strip 4) toward the other second neighboring cavity 8. Thus, a flow of water is possible in a structure 11 over the entire length of the structure between the first and second cavities, in the region of the second face 3, as far as the discharge point of the covering which is typically at a bottom point thereof.

Regarding the intermediate cavities, which are closed in the region of the second surface, they are placed in communication with one another by a drain, for example a longitudinal indentation, formed in the region of the second face 3.

As can be seen in FIGS. 4 to 6, the passages 10 are arranged in the region of the bottom of the covering 1 which simplifies the discharge of water.

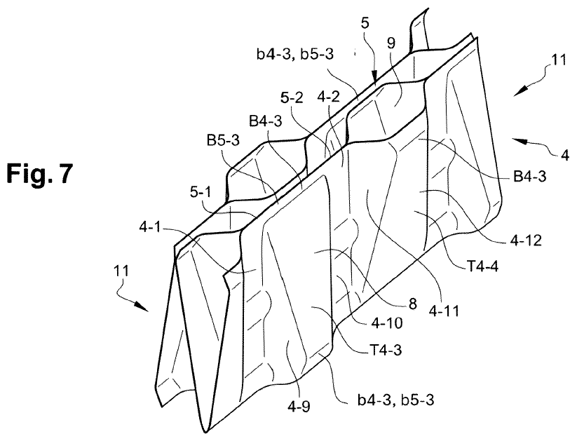

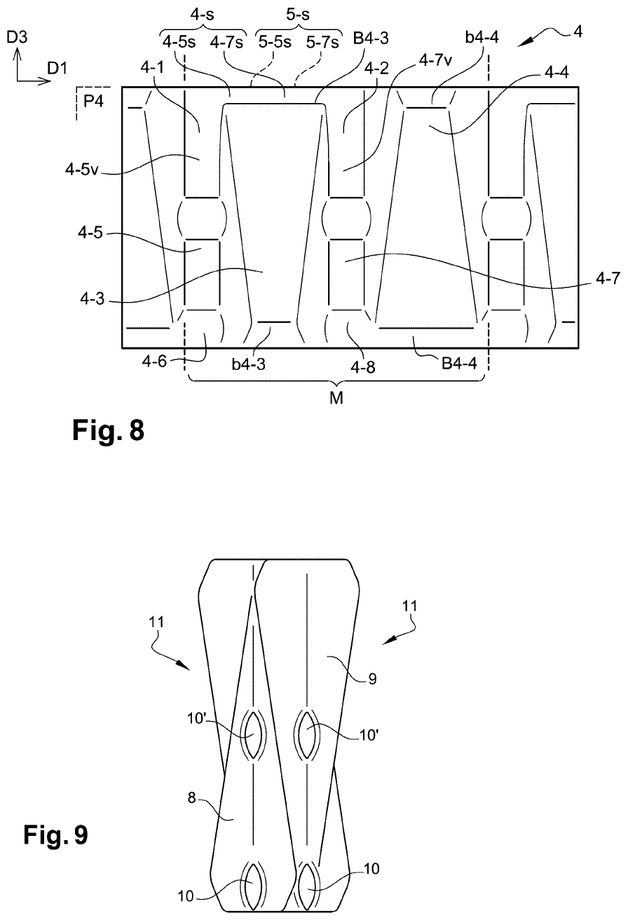

The second embodiment of the invention is now described relative to the FIGS. 7, 8 and 9.

The sound-proofing device D according to this second embodiment is identical to the sound-proofing device D according to the first embodiment, apart from that it comprises an additional level of drainage conduits 10′.

As can be seen in FIGS. 7 to 9, the passages 10′ extend in the covering 1 into the cavities 8, 9 and 12 and into the vertical walls 4-5v, 4-7v, substantially at mid-height of the trapeziums and the vertical walls 4-5v (5-5v) and 4-7v (5-7v).

The passages 10′ extend parallel to the passages 10 in FIGS. 7 to 9.

This embodiment permits a more efficient drainage of condensate since it enables the water discharge rate to be doubled, and also enables the water to be discharged more easily, according to the position of the aircraft.

It is noteworthy that the height of the passages 10′ can vary according to the constraints of the propagation of acoustic waves in the covering 1 and/or according to the manufacturing constraints.

It is also noteworthy that the passages 10′ can be inclined or even convergent with the passages 10, depending on the desired path to be taken by the water in the covering 1.

It is noteworthy that, as a variant, the passages 10′ can be substituted for the passages 10.

The embodiment of FIGS. 7 to 9 will not be described further and reference will be made to the description of the first embodiment for further details.

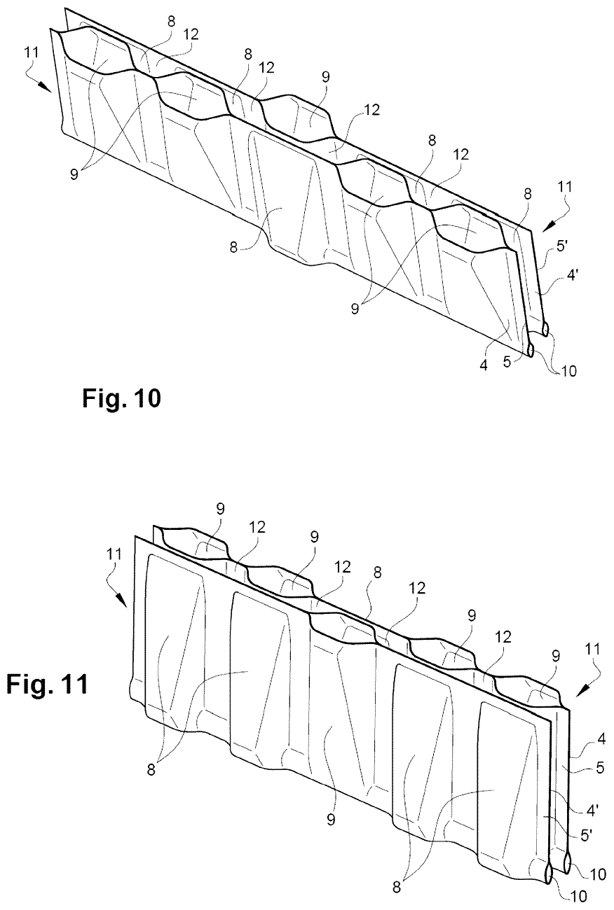

The third embodiment is now described with reference to FIGS. 10, 11 and 12.

This embodiment is similar to the two first embodiments described, in that the sound-proofing device D comprises quarter-wave cavities 8, Helmholtz cavities 9 and intermediate cavities 12 in succession. The device D also comprises sacrificial portions associated with each Helmholtz cavity 8. The device D also comprises drainage passages 10 located in the region of the bottom of the covering 1.

The sound-proofing device D according to this third embodiment differs from the two preceding embodiments by the patterns M.

As is visible in FIGS. 10 to 12, a first pair of strips 4, 5 comprises two successive quarter-wave cavities 9 on either side of each Helmholtz cavity 8. In the detail of FIG. 10, two quarter-wave cavities 9, then one Helmholtz cavity 8 and then two quarter-wave cavities 9, are observed in succession.

A second pair of strips 4′, 5′ comprises two successive Helmholtz cavities 8 on either side of each quarter-wave cavity 9. In the detail of FIG. 10, two Helmholtz cavities 8, then one quarter-wave cavity 9 then two Helmholtz cavities 8, are observed in succession.

This succession of a plurality of Helmholtz cavities 9 makes it possible to increase the bandwidth of the frequencies acoustically treated by the device D and to center the bandwidth at lower frequencies, for example from 1000 Hz to 3000 Hz.

According to this embodiment, the intermediate cavities 12 between a Helmholtz cavity 8 and a quarter-wave cavity 9 are of the hexagonal type, as already described in relation to the two first embodiments. The intermediate cavities 12 between two Helmholtz cavities 8 or two quarter-wave cavities have a different shape, with a cross section delimited by a U-shaped edge and a rectangular edge, in a plane at right-angles to the abutment plane P4, P5.

As already emerges from the above description, for each of the illustrated embodiments, the sacrificial walls guarantee the integrity of the Helmholtz cavities, which makes the sound-proofing device D particularly efficient.

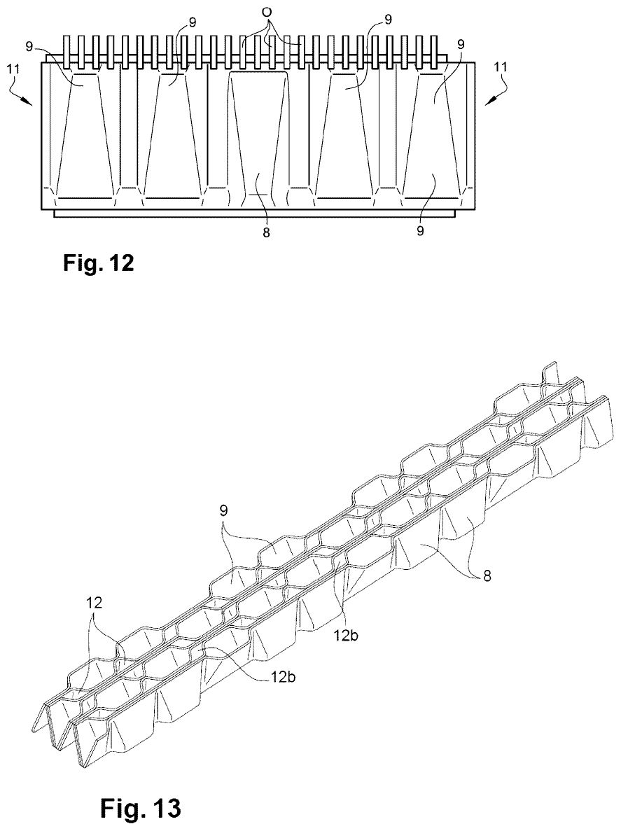

Perforated holes O of the sheet 2 are shown in FIG. 12 to illustrate that the cavities 8 remain intact at the end of this step.

In addition, the frequencies preferably to be absorbed can be selected according to the patterns of the three embodiments.

Moreover, the passages 10, 10′ provide a rapid discharge of any condensate which could damage the device D.

The invention is now described with reference to FIG. 13.

As can be seen in this figure, it is a variant of the embodiment already described in relation to FIGS. 10 to 12.

According to this variant, at least one intermediate cavity, referenced 12b, is closed, for example by adhesive bonding. Preferably, the intermediate cavities 12b are distributed in a regular manner in the covering 1. For example, one row (in the direction D2 for example) of intermediate cavities is blocked at a given rate. In FIG. 13, the rate is one row out of three. The invention is not limited to this rate and, in particular, it is possible to conceive of a rate between 1 row out of 10 and 1 row out of 2, advantageously 1 row out of 3 or 1 row out of 4. According to the direction D1, there are alternately two open cavities and one closed cavity in FIGS. 10 to 12.

Alternatively, the intermediate cavities 12b are distributed in an irregular manner in the covering 1.

Alternatively, the intermediate cavities are filled by material.

Blocking certain intermediate cavities makes it possible to increase even further the bandwidth of the frequencies acoustically treated by the device D and to center the bandwidth to lower frequencies, for example from 500 Hz to 3500 Hz.

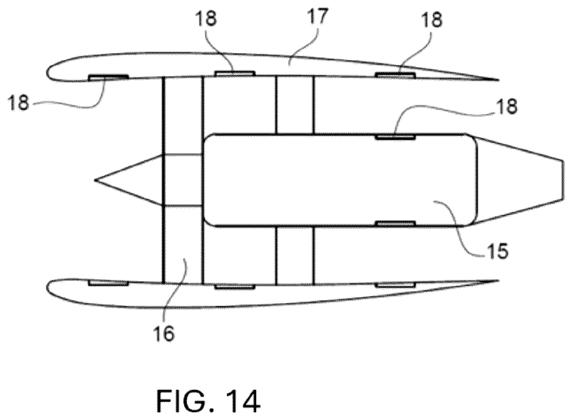

A preferred application of the invention is in the formation of an insulating panel for a nacelle in an aircraft power plant. An aircraft power plant is shown schematically in cross section in FIG. 14. It comprises an engine 15, comprising a turbomachine provided with a fan 16, which is installed in the nacelle 17. The covering 18 can be installed in various locations which are particularly exposed to acoustic waves, in the nacelle and more generally in the power plant. According to one embodiment of the invention, the acoustic covering 18 can be installed so as to form, at least partially, the internal face of the rear part of the nacelle of the aircraft power plant. The covering 18 can be installed in a median zone of the internal face of the nacelle, downstream of the fan 16. The covering 18 can also be installed on an internal face of the rear part of the nacelle. The covering 18 can also be installed on a housing of the engine 15.

The invention thus developed provides an acoustic covering which is capable of treating low frequencies, compared to coverings of the same thickness known from the prior art. Moreover, due to the presence of three sizes of cavities of different shapes, namely first and second cavities in communication with one another to form Helmholtz resonators to treat low frequencies, and intermediate cavities to treat higher frequencies, the range of frequencies treated by the covering is not only shifted relative to a conventional acoustic panel but also increased.

The formation of the covering, in particular the alveolar structure thereof, by complementary geometric structures makes it possible to avoid the abutment of multiple walls, which optimizes the mass of the covering. This covering can be obtained by conventional industrial forming methods, during which it is ensured that there is no damage to the cavities forming the resonators. It is simple to use. The drainage of the water present in the alveolar structure can be carried out in a simple manner. The invention is compatible with the formation of a curved sound-proofing covering. A preferred application of the covering is thus in nacelles of aircraft power plants, the surfaces thereof having one or two radii of curvature.

Modifications and improvements to the above-described embodiments of the present invention can become apparent to a person skilled in the art. In particular, the described embodiments can be combined, provided that they are not incompatible. The above description is illustrative through examples, rather than being limiting. The scope of the present invention is thus solely limited by the scope of the claims below.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A sound insulation device comprising:
a first sheet which is perforated with orifices, called an open sheet, which is permeable to acoustic waves,
a second sheet, called a closing sheet, and
a sound insulation covering arranged between said first sheet and second sheet,
the covering is formed by an abutment in one direction, called a transverse direction, of a plurality of alveolar structures,
each of said alveolar structures is formed by an abutment in the transverse direction of a first longitudinal strip and a second longitudinal strip,
the first strip and the second strip which form the alveolar structure are configured such that said alveolar structure has in a longitudinal direction, at a right angle to the transverse direction:
at least one cavity which is open in a region of the first sheet and of which a cross section gradually reduces between the first sheet and the second sheet until said cavity is closed, called a quarter-wave cavity,
a first abutment of two walls, respectively of the first strip and of the second strip, in contact with each other,
a passage being formed between said quarter-wave cavity and another cavity, said other cavity, called a Helmholtz cavity, which has a cross section gradually increasing between the first sheet and the second sheet and which is closed in the region of the first sheet by a closing edge, and
a second abutment of two walls, respectively of the first strip and of the second strip, in contact with each other,
each of the walls of said first and second abutments comprising a portion arranged along said closing edge of the Helmholtz cavity, called the sacrificial portion, and forming an end of the covering.

2. The device according to claim 1, wherein the sacrificial portion has a height in one direction, called a vertical direction, at right-angles to the longitudinal direction and the transverse direction, of between 1% and 30% of the height in the vertical direction of the covering.

3. The device according to claim 2, wherein the height of the sacrificial portion is between 5% and 25% of the height of the vertical direction of the covering.

4. The device according to claim 1, wherein each sacrificial portion extends in the longitudinal direction and a vertical direction.

5. The device according to claim 1, wherein at least one alveolar structure has a pattern which is repeated along at least one of the longitudinal or transverse directions.

6. The device according to claim 5, wherein the pattern comprises an assembly of one quarter-wave cavity and one Helmholtz cavity in succession.

7. The device according to claim 5, wherein the pattern comprises an assembly of two quarter-wave cavities and one Helmholtz cavity in succession.

8. The device according to claim 5, wherein the pattern comprises an assembly of two Helmholtz cavities and one quarter-wave cavity in succession.

9. The device according to claim 1, wherein at least one of the alveolar structures comprises at least one conduit for discharging water from the covering.

10. The device according to claim 9, wherein at least one of the alveolar structures comprises at least two conduits for discharging water from the covering, each of the two conduits being at a separate given height in a vertical direction.

11. The device according to claim 1, comprising at least one cavity, called an intermediate cavity, which is closed between the Helmholtz cavity and the quarter-wave cavity.

12. The device according to claim 1, wherein the device is for an aircraft.

13. A nacelle for an aircraft engine, comprising a sound insulation device according to claim 1.

14. An aircraft comprising a sound insulation device according to claim 1.
